(19) United States
(12) Patent Application Publication
(10) Pub. No.: US 2016/0292228 A1
(43) Pub. Date: Oct. 6, 2016

(54) METHODS, TERMINAL DEVICE, CLOUD SERVER AND SYSTEM FOR RECOMMENDING WEBSITES

(71) Applicant: TENCENT TECHNOLOGY (SHENZHEN) COMPANY LIMITED, Shenzhen (CN)

(72) Inventor: Jian LIU, Shenzhen (CN)

(21) Appl. No.: 14/442,709

(22) PCT Filed: Nov. 6, 2013
(86) PCT No.: PCT/CN2013/086602

§ 371 Date: May 13, 2015

(30) Foreign Application Priority Data
Nov. 14, 2012 (CN) 201210456802.4

(51) Int. Cl. G06F 17/30; H04L 29/08

(52) U.S. Cl. CPC G06F 17/30466; H04L 67/10; G06F 17/30864

(57) ABSTRACT

According to examples of the present invention, after receiving website information inputted by a user, the terminal device preprocesses the website information according to a Uniform Resource Locator (URL) specification, the preprocessed website information is matched respectively in a website set of local access records by the terminal device and in a domain name database by the cloud server to obtain a second website set and a third website set, then the second website set and the third website set are combined as a union set each website of which is then displayed by the terminal device.

This application claims a priority to Chinese Patent Application No. 201210456802.4 filed on Nov. 14, 2012, the entire contents of all of which are incorporated herein by reference in their entirety for all purposes.

### TECHNICAL FIELD

The present invention relates to a field of information technologies, and particularly, relates to methods for recommending websites, and a corresponding terminal device, cloud server and communication system for recommending websites.

### BACKGROUND

Along with popularization of the Internet, more and more people begin to access various web resources via a browser. Generally, a user needs to input a particular website, i.e., a Uniform Resource Locator (URL), into an address bar of the browser to access a corresponding web resource. Different websites represent different web resources.

In the prior art, when the user is inputting a website, the browser usually completes website information having been inputted and recommends related websites automatically so that the user can complete the inputting of the website rapidly.

### SUMMARY

Embodiments of the present invention provide methods, a terminal device, a cloud server and a communication system for recommending websites.

In a method for recommending websites, website information inputted by a user is received and preprocessed according to a website specification, the preprocessed website information is matched in a website set of local access records to obtain a second website set, and the preprocessed website information is transmitted to a cloud server; a third website set is received from the cloud server, where the third website set is obtain by the cloud server through matching the preprocessed website information in a domain name database which records at least one of domain name popularity, domain name reputation and user selection rate for each website collected at the cloud; and a union set of the second website set and the third website set is computed and is taken as a fourth website set each website of which is displayed on a website recommendation area in a browser.

In another method for recommending websites is provided, and the method includes processes of receiving from a terminal device preprocessed website information which is obtained by the terminal device through preprocessing website information that a user inputs according to a website specification, matching the preprocessed website information in a pre-configured domain name database to obtain a website set, the domain name database recording at least one of domain name popularity, domain name reputation and user selection rate for each of websites collected at the cloud, and transmitting the website set to the terminal device.

In another aspect of the present invention, a terminal device is provided, the terminal device includes: a first receiving unit, adapted to receive website information inputted by a user, a preprocessing unit, adapted to preprocess the website information according to a website specification to obtain preprocessed website information, a matching unit, adapted to match the preprocessed website information in a website set of local access records to obtain a second website set, a transmitting unit, adapted to transmit the preprocessed website information to a cloud server, a second receiving unit, adapted to receive from the cloud server a third website set which is obtain by the cloud server through matching the preprocessed website information in a domain name database recording at least one of domain name popularity, domain name reputation and user selection rate for each of websites collected at the cloud, a computing unit, adapted to compute a union set of the second website set and the third website set, the union set being taken as a fourth website set, and a display unit, adapted to display each website of the fourth website set on a website recommendation area in a browser.

In another aspect of the present invention, a cloud server is provided, the cloud server includes: a receiving unit, adapted to receive from a terminal device preprocessed website information which is obtain by the terminal device through preprocessing website information that a user inputted according to a website specification, a matching unit, adapted to match the preprocessed website information in a pre-configured domain name database to obtain a website set, the domain name database recording at least one of domain name popularity, domain name reputation and user selection rate for each of websites collected at the cloud, and a transmitting unit, adapted to transmit the website set to the terminal device.

In another aspect of the present invention, a communication system is also provided, and the communication system includes at least the above apparatus for recommending websites at the terminal side and the above apparatus for recommending websites at the network side.

In another aspect of the present invention, a machine-readable storage medium is provided, the machine-readable storage medium stores instructions to cause a machine to execute any of the above methods.

### BRIEF DESCRIPTION OF DRAWINGS

FIG. 1 shows a flow chart of a method for recommending websites provided by an example of the present invention.

FIG. 2 shows a flow chart of a method for recommending websites provided by an example of the present invention.

FIG. 3 shows a flow chart of a method for recommending websites provided by an example of the present invention.

FIG. 4 shows a diagram illustrating a structure of a terminal-side apparatus for recommending websites provided by an example of the present invention.

FIG. 5 shows a diagram illustrating a structure of a network-side apparatus for recommending websites provided by an example of the present invention.

### DETAILED DESCRIPTION OF THE INVENTION

Example embodiments will now be described more fully with reference to the accompanying drawings.

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the present disclosure.

As used herein, the term “module” or “unit” or “sub-unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term “module” or “unit” or “sub-unit” may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

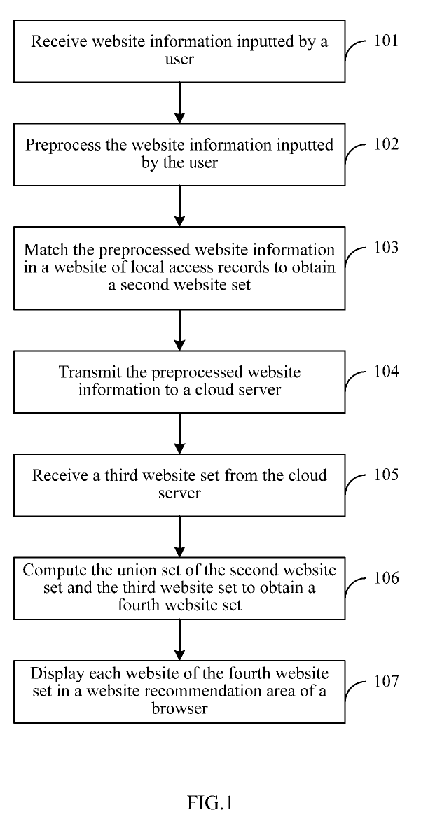

The description will be made as to the various embodiments in conjunction with the accompanying drawings in FIGS. 1-5. It should be understood that specific embodiments described herein are merely intended to explain the present disclosure, but not intended to limit the present disclosure. In accordance with the purposes of this disclosure, as embodied and broadly described herein, this disclosure, in one aspect, relates to method and apparatus for managing an identity for a mobile terminal.

Examples of terminal devices that can be used in accordance with various embodiments include, but are not limited to, a Person Computer (PC), a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to one skilled in the art.

In an example, a terminal-side apparatus for recommending websites is provided. The terminal-side apparatus may specifically be integrated in a terminal device, e.g., it may be a module integrated in the terminal device or may be a plug embedded into a browser of the terminal device or etc.

The example also provides a method for recommending websites which is implemented by a module integrated in the terminal device or a plug embedded into a browser of the terminal device or etc. At the terminal side, website information inputted by a user is received, the website information is preprocessed according to a Uniform Resource Locators (URL) specification, and the preprocessed website information is matched in a website set of local access records to obtain a second website set. Meanwhile, the preprocessed website information is transmitted from the terminal side to a cloud server and the cloud server returns a third website set. Here, the third website set is obtained by the cloud server through matching the preprocessed website information in a domain name database which records domain name popularity, domain name reputation and/or User Selection Rate (USR) for each of websites collected at the cloud. At the terminal side, a union set of the second website set and the third website set is computed and is taken as a fourth website set which is then displayed on a website recommendation area in a browser of the terminal device.

As shown in FIG. 1, the method includes the following steps implemented by a module integrated in the terminal device or a plug embedded into a browser of the terminal device or the like. Herein, the terminal device includes one or more processors and one or more memories storing instructions executable for the one or more processors. While the instructions are executed by the one or more processors, the module or the plug is caused to perform the following steps.

In Step 101, website information inputted by a user is received.

For example, several letters inputted by the user may be received, e.g., three letters “abc” or etc.

In Step 102, the website information received in Step 101 is preprocessed according to a Uniform Resource Locators (URL) specification such as RFC3986.

Here, the preprocessing performed on the website information may include at least one of the followings:

i) A domain name and/or protocol information in the website information is converted into lowercase letters. For example, if the user inputs website information “HTTP://www.Example.com/”, the website information may be converted into “http://www.example.com/”.

ii) When it is determined that there is not any protocol information in website information inputted by a user, a pre-defined protocol head may be added to the website information. For example, if the user inputs website information “www.example.com/”, the website information may be converted into “http://www.example.com/”.

iii) When it is determined that there is no website ending symbol such as a slash “I” in the website information inputted by the user, the website ending symbol may be added to the website information. For example, if the user inputs website information “http://www.example.com”, the website information may be converted into “http://www.example.com/”.

iv) When it is determined that there is an invalid character in the website information inputted by the user, the invalid character may be replaced by a pre-defined corresponding character or be deleted.

A domain name usually includes at least one of twenty six English letters, ten Arabic numerals and a hyphen “-” in which a dot “.” is taken as a separator among words. Other characters that appear in the domain name are regarded as invalid characters, e.g., the user may input a comma “,” or an underscore “_” by mistake. When there is an invalid character that appears in the website information, the invalid character may be replaced by a pre-defined corresponding character, e.g., the comma “,” may be replaced by the dot “.”, and the underscore “_” may be replaced by the hyphen “-”.

In another example, the invalid character is not directly replaced by the pre-defined corresponding character, a reminder to the user may be provided at first, if the user does not do any corrections on the invalid character, then the invalid character will be replaced. For example, the invalid character may be highlighted to prompt the user to correct the inputted invalid character timely. If the user does not do any corrections, and then the invalid character will be replaced or deleted based on comprehensive consideration on distribution of keys on a standard keyboard and website data that users have inputted by mistake which are collected anonymously at the cloud. Here, the comma “,” is replaced by the dot “.”, the underscore “_” is replaced by the hyphen “-”, and other invalid characters are deleted directly, e.g., the website information including the invalid character “http://www,test_example=.com/” is converted into “http://www.test-example.com/”.

In Step 103, the preprocessed website information obtained in Step 102 is matched in a website set of local access records to obtain a set of websites matched with the local access records (i.e., the second website set mentioned above). For example, upon obtaining the preprocessed website information such as a string s, the string s will be matched in a website set of the user's local access records to find a set S that includes all the websites in the website set including the string s.

In an example, the set S may be displayed on a website recommendation area in the browser, after the browser receives a set R including k websites which is recommended by a cloud server, the website recommendation area in the browser will be refreshed.

In Step 104, the preprocessed website information obtained in Step 102 is transmitted to a cloud server.

In Step 105, a set of websites matched at the cloud (i.e., the third website set mentioned above) is received from the cloud server. Herein, the third website set is obtained by the cloud server through matching the preprocessed website information in a domain name database.

Herein, the domain name database is a pre-configured website information database which may record domain name popularity, domain name reputation and/or USR for each of the websites collected at the cloud. The domain name popularity, the domain name reputation and the USR may be calculated according to the following methods.

i) The Domain Name Popularity

The domain name popularity reflects the number of times the websites belonging to a domain name have been accessed by users within a pre-determined period of time, where the pre-determined period of time may be configured according to demands of a practical application.

For example, if the users have accessed the websites belonging to the domain name x times within a week, the domain name popularity y may be calculated as follows:

If x>10,y=log 10(x), and if x≦10,y=1.

ii) The Domain Name Reputation

The domain name reputation reflects the ratio of the number of times all malicious websites belonging to a domain name have been accessed by the users to the number of times all the websites belonging to the domain name have been accessed within a pre-determined period of time, where the pre-determined period of time may be configured according to demands of a practical application.

For example, if the ratio of the number of times all the malicious websites belonging to a domain name have been accessed by the users to the number of times all the websites belonging to the domain name have been accessed within a week is equal to x, the domain name reputation y may be calculated as follows:

y=1−log₁₀(1+x)/log₁₀2, where x ranges from 0 to 1.

iii) The User Selection Rate

The User Selection Rate reflects the probability within a pre-determined period of time that a user would click a website B under the situation of the user inputting website information A and then the browser recommending the website B, where the pre-determined period of time may be configured according to demands of a practical application.

For example, the User Selection Rate may be calculated by dividing the number of times the user has ever clicked the website B within a week under the situation of the user inputting the website information A and then the browser recommending the website B by the number of times the browser has ever recommended the website B within the week under the situation of the user inputting the website information A. Here, the higher the User Selection Rate is, the higher the accuracy of the browser's recommendation is.

In Step 106, the second website set and the third website set are combined to obtain their union set which is a set of recommended websites, i.e., the fourth website set mentioned above.

For example, if the second website set S is obtained in Step 103, and the third website R is obtained in Step 106, then a union set of S and R can be obtained as the fourth website set R∪S.

In Step 107, the fourth website set is displayed on a website recommendation area in the browser. For example, the fourth website set R∪S is obtained in Step 106, each website in the fourth website set R∪S is displayed in the website recommendation area in the browser.

In another example, an option menu may be configured so that through operations on the option menu, the user is able to make an option about whether the websites recommended by the cloud or the websites from the local access records have the priority, that is, whether the websites of the third website set or those of the second website set have the priority. Therefore, the websites of the set R∪S can be displayed on the website recommendation area in an order of priority. Accordingly, the method for recommending websites may further include the following steps:

A display parameter configured by the user is obtained, where the display parameter indicates whether the websites from the second website set or those from the third website set have the priority. The websites of the fourth website set are displayed on the website recommendation area in the browser in an order of priority according to the indication of the obtained display parameter.

In addition, after the fourth website set is displayed on the website recommendation area in the browser (i.e., Step 107), the user may select a website from the fourth website set, and then the website selected by the user may be reported to the cloud server. The cloud server will update the domain name database upon receiving the report of the selected website, so that the cloud server can provide website recommendation with higher accuracy for the user in the future. Accordingly, after Step 107, the method for recommending websites may further include the following steps:

The website that the user selects from the website recommendation area is received, and the selected website is transmitted to the cloud server. Then, the cloud server updates the domain name database according to the selected website.

In the above examples, the preprocessed website information is matched respectively in a website set of local access records and the domain name database in the cloud to obtain a second website set and a third website set which are combined as a union set to be displayed on the website recommendation area in the browser. As the website set of the local access records can reflect usage habits of the user while the domain name database can provide the domain name popularity, domain name reputation and/or the USR for each of the websites, the method provided in these examples, compared to the prior art, can provide more accurate website recommendation for the user, and has higher security on the domain name recommendation, thereby greatly reducing the user's risk on accessing the Internet.

Another example provides a network-side apparatus for recommending websites. The network-side apparatus may specifically be an independent entity or may be integrated in a network-side device, e.g., a cloud server.

This example also provides a method for recommending websites which is implemented by the network-side device. In the method, website information having been preprocessed is received from a terminal device, where the website information is obtained at the terminal device by preprocessing website information inputted by a user according to a URL specification, and the received website information is matched in a pre-configured domain name database to obtain a website set which is then sent to the terminal device. Here, the domain name database records domain name popularity, domain name reputation and/or User Selection Rate (USR) for each website collected at the cloud.

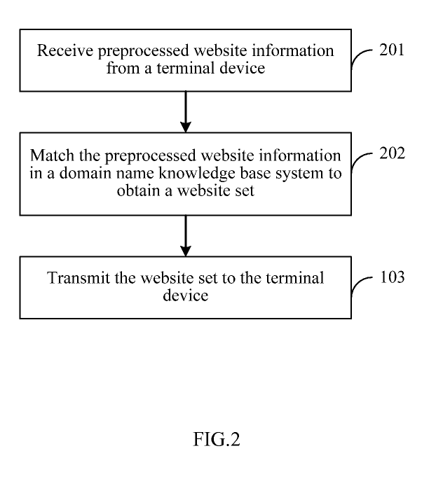

As shown in FIG. 2, the method for recommending websites implemented by the network-side device such as the cloud server may include the following steps. Herein, the cloud server includes one or more processors and one or more memories storing instructions executable for the one or more processors. While the instructions are executed by the one or more processors, the cloud server is caused to perform the following steps.

In Step 201, website information is received from a terminal device. Here, the website information is obtained by the terminal device through preprocessing website information inputted by the user according to a URL specification. The specific method of the preprocessing performed on the website information has been described in the aforementioned examples and will not be discussed again herein.

In Step 202, the website information received in Step 201 is matched in a domain name database to obtain a set of websites matched at the cloud, i.e., the third website set mentioned above.

Specifically, a set of recommended websites is obtained by searching websites including the received website information in the domain name database. A Recommendation Index (RI) is calculated for each member of the set of recommended websites according to domain name popularity, domain name reputation and/or USR of each member of the set of recommended websites, so that the recommended websites can be sequenced into a descending order according to their RIs. And then, the first K websites of the sequenced recommended websites are selected to form the set of websites matched at the cloud, where K is a positive integer. For example, supposing that K is equal to five, the RI is calculated for each member of the set of recommended websites according to the domain name popularity, domain name reputation and/or USR of each member of the set of recommended websites, and then the first five websites of the recommended websites that have been sequenced into a descending order according to their RIs are selected to form the third website set.

Herein, the domain name database is a pre-configured website information database which may record the domain name popularity, domain name reputation and/or USR for each of the websites collected at the cloud. About how to calculate the domain name popularity, domain name reputation and USR, detailed description can be found in the previous examples and will not be discussed herein again.

The domain name database may be configured in a network-side apparatus for recommending websites, e.g., a cloud server, or may be configured in any other server, and the network-side apparatus for recommending websites such as the cloud server may obtain related information from another server configured with the domain name database.

In Step 203, the set of websites matched at the cloud obtained in Step 202, i.e., the third website set, is transmitted to the terminal device.

After the terminal device receives the third website set, a union set of the second website set mentioned above and the third website set can be obtained, the union set is taken as a set of recommended websites, i.e., the fourth website set mentioned above, which is then displayed on a website recommendation area in the browser for the user's selection. Detailed description can be found in the previous examples and will not be discussed herein again.

In an example, after the third website set is transmitted to the terminal device, a website selected from the website recommendation area by the user is received from the terminal device, the domain name database is updated according to the website selected by the user, thereby more accurate website recommendation can be provided.

In addition, before the website information preprocessed is received from the terminal device, the method for recommending websites may further include establishing a domain name database according to domain name popularity, domain name reputation and/or USR of each of the websites collected at the cloud.

In the above examples, after receiving website information having been preprocessed from the terminal device, the pre-processed website information is matched in the domain name database to obtain a set of websites matched at the cloud which is then provided with the terminal device so that the terminal device can combine the set of websites matched with the local access records and the set of websites matched at the cloud to form a union set, and each of the websites of the union set is displayed on the website recommendation area in the browser. As the domain name database can provide the domain name popularity, domain name reputation and/or the USR for each of the websites, the method provided in these examples, compared to the prior art, can provide more accurate website recommendation for the user, and has higher security on the domain name recommendation, thereby greatly reducing the user's risk on accessing the Internet.

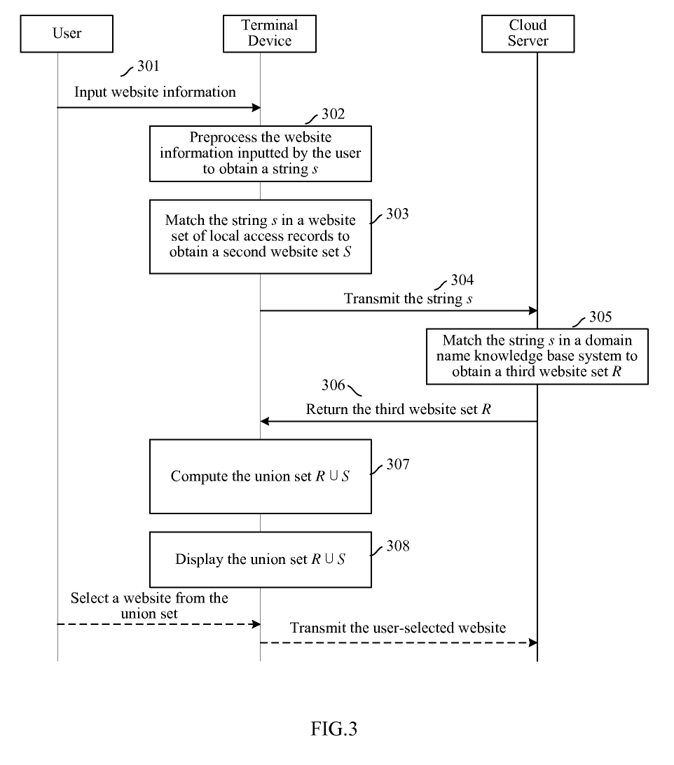

Another example provides a method for recommending websites which involve interactions between the terminal device and the cloud server. As shown in FIG. 3, the method for recommending implemented by the terminal device and the cloud server websites includes the following steps. Herein, the terminal device and the cloud server include one or more processors and one or more memories storing instructions executable for the one or more processors. While the instructions are executed by the one or more processors, the terminal device and the cloud server are caused to perform the following steps.

In Step 301, a terminal device receives website information inputted by a user. For example, the terminal device receives several letters such as “Exam” that the user inputs.

In Step 302, the terminal device preprocesses the website information the user inputs in Step 301 according to a URL specification such as RFC3986 and obtains the preprocessed website information, e.g., a string s. In the following steps, it is supposed that the preprocessed website information is the string s. Specific method of the preprocessing performed on the website information has been described in the previous examples, and will not be discussed herein.

In Step 303, the terminal device matches the string s obtained by preprocessing the user-inputted website information in a website set of local access records to find a set S that includes all the websites including the string s and the set S is regarded as a set of websites matched with the local access records (i.e., a second website set).

In an example, the terminal device may present the second website set S on a website recommendation area in the browser, and update the website recommendation area upon receiving from the cloud server a set of websites matched at the cloud (i.e., a third website set).

In Step 301, the terminal device transmits the string s to the cloud server.

In Step 305, upon receiving the string s, the cloud server matches the string s in a domain name database to obtain the third website set R.

Specifically, a website set W is obtained by searching websites including the string s in the domain name database. A Recommendation Index (RI) is calculated for each member of the website set W according to domain name popularity, domain name reputation and/or USR of each member of the website set W, the websites of the website set W are sequenced into a descending order according to their RIs, and then the first K websites of the sequenced websites are selected to form the third website set R.

Here, based on the comparison between the string s and the websites set W, the RI can be calculated by the following formula:

RI(r|s)=Sim(r,s)×Popularity(r)×Reputation(r)×USR(r|s),rεW

RI(r|s) represents the RI of a website r when the preprocessed website information is the string s, and the higher the RI(r|s) is, the more probability of being recommended the website r has.

Sim(r, s) represents the similarity between the website r and the string s which is obtained by calculating an editing distance tween them. The editing distance (namely a Levenshtein distance) refers to the minimum number of editing operation(s) needed to convert one string into another string, where the editing operation may be replacing one character to another, inserting one character or delete one character or etc. The similarity is equal to the inverse of the sum of the edition distance plus 1. For example, supposing the editing distance between two strings “abcd” and “bcd” is equal to 1, the similarity of the two strings is equal to 0.5 which is calculated by the formula “1/(1+1)=0.5”.

Popularity(r) and Reputation(r) respectively represent the domain name popularity and the domain name reputation of the website r, and USR(r|s) represents the User Selection Rate of the recommended website r when the string s is inputted.

After the RI is calculated, the cloud server selects K websites with the highest RI(s) among the websites of the website set W to form the third website set, and transmits the third website set to the terminal device.

Herein, K is a positive integer and can be configured according to a practical application. Specifically, the value of K may be configured and dynamically adjusted according to the performance of the terminal device and the network quality. For example, for the users of a faster network speed, K may ranges from 5 to 10 while K may ranges from 3 to 5 for those of a slower network speed in order to save bandwidth.

In Step 306, the cloud server transmits the third website set R to the terminal device.

In Step 307, upon receiving the third website set R, the terminal device calculates the union set of the second website set and the third website set to obtain a set of recommended websites R∪S, i.e., the fourth website set.

In Step 308, the terminal device displays the set of recommended websites R∪S on a website recommendation area in the browser.

In an example, an option menu may be configured so that through operations on the option menu, the user is able to make an option on whether the website recommended by the cloud or the website from the local access records has the priority, that is, whether the website of the third website set or that of the second website set has the priority. Therefore, the websites of the set R∪S can be displayed on the website recommendation area in an order of priority.

In addition, after the website set R∪S is displayed on the website recommendation area in the browser, the user may select a website from the website set R∪S, and then the website selected by the user may be reported to the cloud server. The cloud server will update the domain name database upon receiving the report of the selected website, so that the cloud server can provide more accurate website recommendation for the user in the future.

It can be seen that in the above examples, after receiving website information inputted by a user, the terminal device preprocesses the website information according to the URL specification, and the preprocessed website information is matched respectively in a website set of local access records and the domain name database in the cloud to obtain a second website set S matched with the local access records and a third website set R matched at the cloud. Then the second website set S and the third website set R are combined as a union set R∪S, and each of the websites of the union set R∪S is displayed on the website recommendation area in the browser for the user's selection. As the website set of the local access records can reflect usage habits of the user while the domain name database can provide the domain name popularity, domain name reputation and/or the USR for each of the websites, the method of the present invention, compared to the prior art, can provide more accurate website recommendation for the user, and has higher security on the domain name recommendation, thereby greatly reducing the user's risk on accessing the Internet.

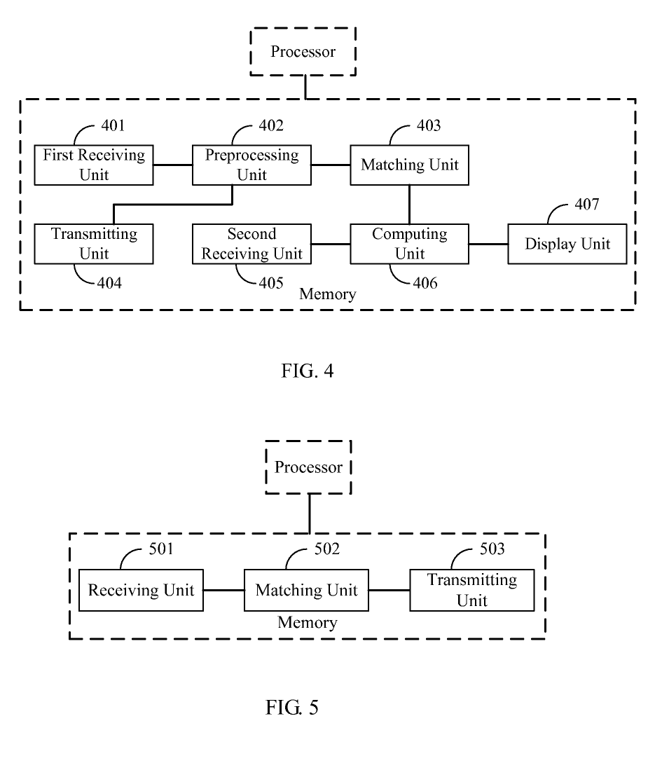

Another example provides a terminal-side apparatus for recommending websites. The terminal-side apparatus for recommending websites may be integrated in the terminal device, for example, it may be a module integrated in the terminal device or a plug embedded in the browser of the terminal device or etc. As shown in FIG. 4, the apparatus for recommending websites includes a first receiving unit 401, a preprocessing unit 402, a matching unit 403, a transmitting unit 404, a second receiving unit 405, a computing unit 406 and a display unit 407.

The first receiving unit 401 is to receive website information inputted by a user, e.g., receive several letters such as “abc” inputted by the user.

The preprocessing unit 402 is to preprocess the website information inputted by the user according to a URL specification, e.g., RFC3986, and obtain the preprocessed website information.

The matching unit 403 is to match the preprocessed website information obtained by the preprocessing unit 402 in a website set of local access records to obtain a set of websites matched with the local access records, i.e., a second website set.

The transmitting unit 404 is to transmit the preprocessed website information to a cloud server.

The second receiving unit 405 is to receiving a set of websites matched at the cloud, i.e., a third website set, where the second website set is obtained by the cloud server matching the preprocessed website information transmitted by the transmitting unit 404 in a domain name database which has been described in the previous examples and will not be discussed again herein.

The computing unit 406 is to compute the union set of the second website set and the third website set to obtain a set of recommended websites, i.e., a fourth website set.

The display unit 407 is adapted to display the fourth website set obtained by the computing unit 406 on a website recommendation area in the browser.

The preprocessing unit 402 may include a converting sub-unit, an adding sub-unit and a replacement sub-unit.

The converting sub-unit is to convert a domain name and/or protocol information in the website information inputted by the user into lowercase letters. For example, if the user inputs website information “HTTP://www.Example.com/”, the website information may be converted into “http://www.example.com/”.

The adding sub-unit is to add a pre-defined protocol head to the website information inputted by the user when it is determined that there is no protocol information in the inputted website information, and/or to add a website ending symbol to the website information inputted by the user when it is determined that there is no website ending symbol such as a slash “/” in the inputted website information. For example, if the user inputs website information “www.example.com/”, the website information may be converted into “http://www.example.com/”. For another example, if the user inputs website information “www.example.com”, the website information may be converted into “http://www.example.com/”.

The replacement sub-unit is to when it is determined that there is an invalid character in the website information inputted by the user, replace the invalid character by a pre-defined corresponding character or delete the invalid character, where the specific method of the replacement of the invalid character has been described in the above embodiments and will not be discussed herein.

In an example, the replacement sub-unit may not directly replace the invalid character by the pre-defined corresponding character but provide a reminder to the user at first. If the user does not do any corrections on the invalid character, then the invalid character will be replaced. For example, the invalid character may be highlighted to prompt the user to correct the inputted invalid character timely, if the user still does not do any corrections, and then the invalid character will be replaced or deleted based on comprehensive consideration on distribution of keys on a standard keyboard and website data that users have inputted by mistake which are collected anonymously by the cloud. Here, the comma “,” is replaced by the dot “.”, the underscore “_” is replaced by the hyphen “-”, and other invalid characters are deleted directly, e.g., the website information including the invalid character “http://www,test_example=.com/” is converted into “http://www.test-example.com/”.

In an example, an option menu may be configured so that through operations on the option menu, the user is able to make an option on whether the website recommended by the cloud or the website from the local access records has the priority. Therefore, the websites of the set of recommended websites can be displayed on the website recommendation area in an order of priority. Accordingly, the display unit 407 may include a parameter obtaining sub-unit and a display sub-unit.

The parameter obtaining sub-unit is to obtain a display parameter configured by the user, where the display parameter indicates whether the websites of the second website set or those of the third website set have the priority.

The display sub-unit is to display the websites of the fourth website set obtained by the computing unit 406 on the website recommendation area in the browser in an order of priority according to the indication of the display parameter obtained by the parameter obtaining sub-unit.

In addition, after the fourth website set is displayed on the website recommendation area in the browser, the user may select a website from the fourth website set, and then the website selected by the user may be reported to the cloud server. The cloud server will update the domain name database upon receiving the report of the selected website, so that the cloud server can provide website recommendation with higher accuracy for the user in the future.

Accordingly, the first receiving unit 401 is further to receive the website that the user selects from the website recommendation area, and the transmitting unit 404 is further to transmit the selected website to the cloud server, so that the cloud server is able to update the domain name database according to the selected website.

Specifically, the above units and sub-units may be respective independent entities, or these units may form one or more entities where all or any combination of the units may be integrated in the same entity. The specific implementations of the functions of the units have been described in the above method embodiments and will not be discussed again herein.

It can be seen that in the above examples, after the first receiving unit 401 receives website information inputted by a user, the website information is preprocessed by the preprocessing unit 402 according to the URL specification, and the matching unit 403 matches the preprocessed website information in a website set of local access records to obtain the second website set, and the second receiving unit 405 receives from the cloud server the third website set which is obtained by matching the preprocessed website information in the domain name database. Then the computing unit 406 combines the second website set and the third website set as a union set thereof, and the display unit 407 displays each of the websites of the union set on the website recommendation area in the browser. As the website set of the local access records can reflect usage habits of the user while the domain name database can provide the domain name popularity, domain name reputation and/or the USR for each of the websites, the apparatus of the present invention, compared to the prior art, can provide more accurate website recommendation for the user, and has higher security on the domain name recommendation, thereby greatly reducing the user's risk on accessing the Internet.

Another example provides a network-side apparatus for recommending the website which may be integrated in a network-side device such as a cloud server. As shown in FIG. 5, the apparatus includes a receiving unit 501, a matching unit 502 and a transmitting unit 503.

The receiving unit 501 is to receive website information having been preprocessed from a terminal device, where the website information having been preprocessed is obtained by the terminal device preprocessing website information inputted by a user according to a URL specification. The specific preprocessing performed on the website information has been described in the previous examples and will not be discussed again herein.

In an example, the invalid character is not directly replaced by the pre-defined corresponding character, a reminder to the user may be provided at first, if the user does not do any corrections on the invalid character, then the invalid character will be replaced. For example, the invalid character may be highlighted to prompt the user to correct the inputted invalid character timely, if the user still does not do any corrections, and then the invalid character will be replaced or deleted based on comprehensive consideration on distribution of keys on a standard keyboard and website data that users have inputted by mistake which are collected anonymously by the cloud. Here, the comma “,” is replaced by the dot “.”, the underscore “_” is replaced by the hyphen “-”, and other invalid characters are deleted directly.

The matching unit 502 is to match the preprocessed website information received by the receiving unit 501 in a pre-configured domain name database to obtain a set of websites matched at the cloud, i.e., the third website set mentioned above. Herein, the domain name database has been described in the previous examples and will not be discussed again herein.

The transmitting unit 503 is to transmit the third website set to the terminal device. Such that, the union set of the set of websites matched with the local access records (i.e., the second website set mentioned above) and the third website set can be obtained upon the terminal device receiving the third website set, and the union set can be displayed as a set of recommended websites on a website recommendation area in the browser for the user's selection. The specific processing at the terminal device has been described in the above embodiments and will not be discussed again herein.

The matching unit 502 may include a searching sub-unit, a sequencing sub-unit and a selection sub-unit.

The searching sub-unit is to search any website including the preprocessed website information in the domain name database to obtain a website set.

The sequencing unit is to calculate a Recommendation Index (RI) for each website of the website set obtained by the searching sub-unit according to the domain name popularity, domain name reputation and/or USR thereof, and sequence the websites of the website set obtained by the searching sub-unit in a descending order according to their RIs.

The selection sub-unit is to select the first K websites among the sequenced websites of the website set obtained by the searching sub-unit to obtain the third website set, where K is a pre-defined positive integer.

After transmitting the third website set to the terminal device, the transmitting unit 503 is further to receive the website that the user selects from the website recommendation area, and update the domain name database according to the selected website, so that more accurate website recommendation can be provided for the user.

Accordingly, the network-side apparatus for recommending the website may further include an update unit. The receiving unit 501 is further to receive from the terminal device the website that the user selects from the website recommendation area. The update unit is to update the domain name database according to the selected website received by the receiving unit 501.

In addition, the network-side apparatus for recommending the website may further include an establishment unit which is to establish the domain name database according to the domain name popularity, domain name reputation and/or USR of each website collected at the cloud. The specific description of the domain name database can be found in the previous examples and will not be discussed again herein.

Specifically, the above units may be respective independent entities, or these units may form one or more entities where all or any combination of the units may be integrated in the same entity. The specific implementations of the functions of the units have been described in the above method embodiments and will not be discussed again herein.

It can be seen that in these examples, after the receiving unit 501 receives preprocessed website information, the matching unit 502 matches the preprocessed website information in the domain name database to obtain the third website set which is then transmitted to the terminal device by the transmitting unit 503, so that the terminal device can combine the second website set matched in local and the third website set as a union set thereof, and displays each of the websites of the union set on the website recommendation area in the browser. As the second website set can reflect usage habits of the user while the domain name database can provide the domain name popularity, domain name reputation and/or the USR for each of the websites, the apparatus of the present invention, compared to the prior art, can provide more accurate website recommendation for the user, and has higher security on the domain name recommendation, thereby greatly reducing the user's risk on accessing the Internet.

Another example provides a communication system including any of the above-mentioned terminal-side apparatuses for recommending the website and any of the above-mentioned network-side apparatuses for recommending the website. For example, the terminal-side apparatus may be a terminal device while the network-side apparatus may be a cloud server.

In this example, the terminal device is to receive website information inputted by a user, preprocess the website information according to a URL specification to obtain preprocessed website information, match the preprocessed website information in a website set of local access records to obtain a second website set, and transmit the preprocessed website information to the cloud server, receive a third website set from the cloud server, compute a union set of the second website set and the third website set and take the union set as set of recommended websites, and display the set of recommended websites on a website recommendation area in the browser. The cloud server is to receive from the terminal device the preprocessed website information, match the preprocessed website information in a domain name database to obtain the third website set, and transmit the third website set to the terminal device.

Here, the specific implementation of the terminal device and the cloud server may refer to the previous examples and will not be discussed again herein.

It can be seen in this example, after receiving website information inputted by a user, the terminal device preprocesses the website information according to the URL specification, and matches the preprocessed website information respectively in the website set of local access records and the domain name database in the cloud server to obtain the second website set and the third website set. Then, the terminal device combines the second website set and the third website set as a union set thereof and displays each of the websites of the union set on the website recommendation area in the browser. As the website set of the local access records can reflect usage habits of the user while the domain name database can provide the domain name popularity, domain name reputation and/or the USR for each of the websites, the communication system of the present invention, compared to the prior art, can provide more accurate website recommendation for the user, and has higher security on the domain name recommendation, thereby greatly reducing the user's risk on accessing the Internet.

The methods, modules, units and sub-units described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

Accordingly, as shown in FIG. 4, the first receiving unit 401, the preprocessing unit 402, the matching unit 403, the transmitting unit 404, the second receiving unit 405, the computing unit 406 and the display unit 407 may be instructions stored in a memory of a terminal device, and a processor of the terminal device is to execute the instructions stored in the memory to enable the terminal device to perform the functions of the units 401˜407. Thus, the present disclosure also provides a terminal device which includes one or more processors, a memory and one or more instruction units stored in the memory and to be executed by the one or more processors, the one or more instruction units include the units 401˜407. Further, as shown in FIG. 5, the receiving unit 501, the matching unit 502 and the transmitting unit 503 may be instructions stored in a memory of a cloud server, and a processor of the cloud server is to execute the instructions stored in the memory to enable the cloud server to perform the functions of the units 501˜503. Thus, the present disclosure further provides a cloud server which includes one or more processors, a memory and one or more instruction units stored in the memory and to be executed by the one or more processors, the one or more instruction units include the units 501˜503.

A machine-readable storage medium is also provided, which is to store instructions to cause a machine such as the terminal device and/or the cloud server to execute one or more methods as described herein. Specifically, a system or apparatus having a storage medium that stores machine-readable program codes for implementing functions of any of the above examples and that may make the system or the apparatus (or CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above examples.

In addition, the program codes implemented from a storage medium are written in storage in an extension board inserted in the computer or in storage in an extension unit connected to the computer. In this example, a CPU in the extension board or the extension unit executes at least part of the operations according to the instructions based on the program codes to realize a technical scheme of any of the above examples.

The above description just shows several examples of the present invention in order to present the principle and implementation of the present invention, and is in no way intended to limit the scope of the present invention. Any modifications, equivalents, improvements and the like made within the spirit and principle of the present invention should be encompassed in the scope of the present invention.

1. A method for recommending websites, comprising:
receiving, by a terminal device, website information inputted by a user;
preprocessing, by the terminal device, the website information according to a Uniform Resource Locator (URL) specification;
matching, by the terminal device, the preprocessed website information in a website set of local access records to obtain a second website set;
transmitting, by the terminal device, the preprocessed website information to a cloud server;
receiving, by the terminal device, from the cloud server a third website set which is obtain by the cloud server through matching the preprocessed website information in a domain name database recording at least one of domain name popularity, domain name reputation and user selection rate for each of websites collected at cloud;
computing, by the terminal device, a union set of the second website set and the third website set, the union set being taken as a fourth website set; and
displaying, by the terminal device, each website of the fourth website set.

2. The method of claim 1, wherein a process of preprocessing the website information comprises at least one of:
converting a domain name and/or protocol information in the website information into lowercase letters;
adding a pre-defined protocol head to the website information when it is determined that there is no protocol information in the website information;
adding a website ending symbol to the website information when it is determined that there is no website ending symbol in the website information; and
when it is determined that there is an invalid character in the website information, replacing the invalid character by a pre-defined corresponding character or deleting the invalid character.

3. The method of claim 1, wherein a process of displaying each website of the fourth website set comprises:
obtaining a display parameter configured by the user, the display parameter indicating whether the website from the second website set or that from the third website set has the priority; and
displaying the websites of the fourth website set in an order of priority according to the indication of the obtained display parameter.

4. The method of claim 1, further comprising:
receiving, by the terminal device, a website that the user selects from the websites displayed; and
transmitting, by the terminal device, the selected website to the cloud server which is capable of updating the domain name database according to the selected website.

5. A method for recommending websites, comprising:
receiving, by a cloud server, from a terminal device preprocessed website information which is obtained by the terminal device through preprocessing website information inputted by a user according to a Uniform Resource Locator (URL) specification;
matching, by the cloud server, the preprocessed website information in a pre-configured domain name database to obtain a website set, the domain name database recording at least one of domain name popularity, domain name reputation and user selection rate for each of websites collected at cloud; and
transmitting, by the cloud server, the website set to the terminal device.

6. The method of claim 5, wherein a process of matching the preprocessed website information in the pre-configured domain name database to obtain the website set comprises:
searching the domain name database to obtain a first website set comprising websites comprising the preprocessed website information;
calculating a recommendation index for each website of the first website set according to at least one of the domain name popularity, the domain name reputation and the user selection rate of each website of the first website set;
sequencing the websites of the first website set in a descending order according to the recommendation indexes of the websites of the first website set; and
selecting the first one or more websites among the websites of the first website sequenced in the descending order to form a second website set which is to be transmitted to the terminal device.

7. The method of claim 5, wherein a process of preprocessing the website information comprises at least one of:
converting a domain name and/or protocol information in the website information into lowercase letters;
adding a pre-defined protocol head to the website information when it is determined that there is no protocol information in the website information;
adding a website ending symbol to the website information when it is determined that there is no website ending symbol in the website information; and
when it is determined that there is an invalid character in the website information, replacing the invalid character by a pre-defined corresponding character or deleting the invalid character.

8. The method of claim 5, further comprising:
receiving, by the cloud server, from the terminal device a website that the user selects from websites displayed on a website recommendation area in a browser; and
updating, by the cloud server, the domain name database according to the selected website.

9. The method of claim 5, further comprising:
establishing, by the cloud server, the domain name database according to at least one of domain name popularity, domain name reputation and user selection rate for each of websites collected at cloud.

10. A terminal device, comprising:
a first receiving unit, to receive website information inputted by a user;
a preprocessing unit, to preprocess the website information according to a Uniform Resource Locator (URL) specification;
a matching unit, to match the preprocessed website information in a website set of local access records to obtain a second website set;
a transmitting unit, to transmit the preprocessed website information to a cloud server;
a second receiving unit, to receive from the cloud server a third website set which is obtain by the cloud server through matching the preprocessed website information in a domain name database recording at least one of domain name popularity, domain name reputation and user selection rate for each of websites collected at cloud;
a computing unit, to compute a union set of the second website set and the third website set, the union set being taken as a fourth website set; and
a display unit, to display each website of the fourth website set.

11. The terminal device of claim 10, wherein the preprocessing unit comprises a converting sub-unit, an adding sub-unit and a replacement sub-unit;
the converting sub-unit is to convert a domain name and/or protocol information in the website information inputted by the user into lowercase letters;
the adding sub-unit is to add a pre-defined protocol head to the website information inputted by the user when it is determined that there is no protocol information in the website information inputted by the user, and/or to add a website ending symbol to the website information inputted by the user when it is determined that there is no website ending symbol in the website information inputted by the user; and
the replacement sub-unit is to when it is determined that there is an invalid character in the website information inputted by the user, replace the invalid character by a pre-defined corresponding character or to delete the invalid character.

12. The terminal device of claim 10, wherein the display unit comprises a parameter obtaining sub-unit and a display sub-unit;
the parameter obtaining sub-unit is to obtain a display parameter configured by the user, the display parameter indicating whether the website of the second website set or that of the third website set has the priority; and
the display sub-unit is to display the websites of the fourth website set in an order of priority according to the indication of the display parameter.

13. The terminal device of claim 10, wherein the first receiving unit is further to receive a website that the user selects from the websites displayed on the website recommendation area, and the transmitting unit is further to transmit the selected website to the cloud server which is to update the domain name database according to the selected website.

14.-19. (canceled)
